(19) United States
(12) Patent Application Publication
(10) Pub. No.: US 2009/0172732 A1
(43) Pub. Date: Jul. 2, 2009

(54) Method and Apparatus for Providing a Dynamic Programming Guide Containing Future Times When On-Demand Broadcasting Requests Can be Satisfied

(75) Inventors: Brett Lindsley, Wheaton, IL (US); Matt Defano, Chicago, IL (US); Jianjun Fang, Long Grove, IL (US); Bhavan Gandhi, Vernon Hills, IL (US); Alfonso Martinez Smith, Algonquin, IL (US); Robert G. Scheffler, Peyton, CO (US)

Correspondence Address: MOTOROLA/FETF, 120 SOUTH LASALLE STREET, SUITE 1600, CHICAGO, IL, 60603-3406, US

(73) Assignee: MOTOROLA, INC., Schaumburg, IL (US)

(21) Appl. No.: 11/965,073

(22) Filed: Dec. 27, 2007

(51) Int. Cl. G06F 3/00

(52) U.S. Cl. 725/39

(57) ABSTRACT

An audio-visual content service provider (400) processor (401) receives (101) at least one on-demand broadcasting request for particular audio-visual content from an end user (405). The processor then determines (102) at least one future time at which the on-demand broadcasting request can likely be satisfied and provides (103) a corresponding dynamic programming guide to the end user that comprises, at least in part, this at least one future time.

### RELATED APPLICATION(S)

This application is related to co-pending and co-owned attorney's docket number CML06334 (7303/91204), entitled METHOD AND APPARATUS TO FACILITATE THE LOCAL RECORDING OF AUDIO-VISUAL CONTENT FOR SUBSEQUENT RE-BROADCASTING IN THE ABSENCE OF END USER REQUESTS and filed on even date herewith, which is incorporated by reference in its entirety herein.

This application is related to co-pending and co-owned attorney's docket number CML06335 (7303/91205), entitled METHOD AND APPARATUS TO FACILITATE PROVIDING ON-DEMAND ACCESS TO INTERNET MEDIA CONTENT WITH OTHER TELEVISED CONTENT and filed on even date herewith, which is incorporated by reference in its entirety herein.

This application is related to co-pending and co-owned attorney's docket number CML06333 (7303/91203), entitled METHOD AND APPARATUS FOR METADATA-BASED CONDITIONED USE OF AUDIO-VISUAL CONTENT and filed on even date herewith, which is incorporated by reference in its entirety herein.

### TECHNICAL FIELD

This invention relates generally to audio-visual content-based services and more particularly to the provision of audio-visual content to service provider end users.

### BACKGROUND

Audio-visual materials of various kinds are well known in the art as are various ways of conveying such content to an end user to facilitate the consumption of the former by the latter. In many cases, an audio-visual content service provider obtains such audio-visual content from one or more content providers and arranges for the distribution of that content to one or more end users. In the case of televised audio-visual content, such an audio-visual content service provider often comprises, for example, a Community Access Television (CATV) service provider, an Internet Provider Television (IPTV) service provider, a mobile device service provider (such as a cellular telephony service provider), or the like.

In many cases this audio-visual content is distributed to the end user pursuant to a scheduled multipoint broadcast. By this approach, an audience of end users collectively all independently select a particular scheduled channel at a particular scheduled time on a particular scheduled day to receive a given predetermined and scheduled presentation of a given item of audio-visual content. In many cases such presentations are scheduled days, weeks, or even months in advance. Such an approach, of course, offers little viewing flexibility for the end user.

As a partial attempt to meet these inadequacies, some audio-visual content service providers provide so-called video on demand (VOD) services. By this approach, the end user can make a selection from amongst a relatively small and limited number of audio-visual content items (often relatively recent theatrical releases). Upon making such a selection at a time of convenience, the end user is then able to begin receiving the selected item. Though gaining in popularity, such VOD services nevertheless fail in significant regards to meet the needs of end users in this regard.

As noted, such offerings are usually highly limited in number. These limitations are due to any of a variety of reasons including bandwidth limitations that limit the number on-demand requests that can be simultaneously satisfied by a given service provider's access network.

### BRIEF DESCRIPTION OF THE DRAWINGS

The above needs are at least partially met through provision of the method and apparatus for providing a dynamic programming guide containing future times when on-demand broadcasting requests can be satisfied described in the following detailed description, particularly when studied in conjunction with the drawings, wherein:

FIG. 1 comprises a flow diagram as configured in accordance with various embodiments of the invention;

FIG. 2 comprises a view of various displays as are configured in accordance with various embodiments of the invention;

FIG. 3 comprises a view of various displays as are configured in accordance with various embodiments of the invention:

FIG. 4 comprises a block diagram as configured in accordance with various embodiments of the invention; and

FIG. 5 comprises a block diagram as configured in accordance with various embodiments of the invention.

Skilled artisans will appreciate that elements in the figures are illustrated for simplicity and clarity and have not necessarily been drawn to scale. For example, the dimensions and/or relative positioning of some of the elements in the figures may be exaggerated relative to other elements to help to improve understanding of various embodiments of the present invention. Also, common but well-understood elements that are useful or necessary in a commercially feasible embodiment are often not depicted in order to facilitate a less obstructed view of these various embodiments of the present invention. It will further be appreciated that certain actions and/or steps may be described or depicted in a particular order of occurrence while those skilled in the art will understand that such specificity with respect to sequence is not actually required. It will also be understood that the terms and expressions used herein have the ordinary technical meaning as is accorded to such terms and expressions by persons skilled in the technical field as set forth above except where different specific meanings have otherwise been set forth herein.

### DETAILED DESCRIPTION

Generally speaking, pursuant to these various embodiments, an audio-visual content service provider processor receives at least one on-demand broadcasting request for particular audio-visual content from an end user. The processor then determines at least one future time at which the on-demand broadcasting request can likely be satisfied and provides a corresponding dynamic programming guide to the end user that comprises, at least in part, this at least one future time.

There are various ways by which the audio-visual content service provider process can make the aforementioned determination regarding this future time at which the on-demand broadcasting request can likely be satisfied. By one approach, for example, this can comprise making this determination as a function, at least in part, of a level of service to be accorded to the end user. As another example, this determination can be made as a function, at least in part, of anticipated broadcasting bandwidth demands. These teachings will also accommodate making this determination, at least in part, as based on an indication of relative priority as provided, for example, by the requesting end user.

So configured, those skilled in the art will recognize and appreciate that these teachings provide a flexible and highly scalable mechanism for determining when one or more on-demand broadcasting requests can likely be satisfied for a given end user and then communicating those determinations to the end user via a dynamic programming guide. Those skilled in the art will appreciate that such a dynamic programming guide can also comprise, if desired, information regarding regularly scheduled broadcasts of audio-visual content as well as the future times for requested on-demand content.

By this approach, when an on-demand cannot be immediately met by the audio-visual content service provider for whatever reason, the end user can nevertheless be apprised of a future time when the request can be satisfied. This, in turn, can permit the end user to take an appropriate responsive action. For example, the end user can choose to adjust their own viewing schedule or to use the provided information regarding the future time to program a home audio-visual recorder to capture the on-demand broadcast. Other possibilities in this regard exist as well.

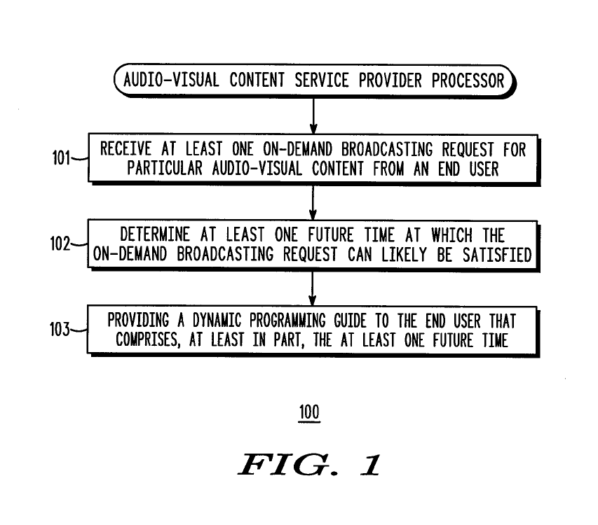

These and other benefits may become clearer upon making a thorough review and study of the following detailed description. Referring now to the drawings, and in particular to FIG. 1, an illustrative process that is compatible with many of these teachings will now be presented.

This process 100 can be carried out at an audio-visual content service provider such as, but not limited to, a Community Access Television (CATV) service provider (which can comprise, for example, a cable-based service provider or a satellite-based service provider), an Internet Protocol Television (IPTV) service provider, a mobile device service provider such as a cellular telephony service provider, and so forth. More particularly, this process 100 can be effectuated at the head end facilities of the audio-visual content service provider as versus, for example, at the facilities of the content providers or at the facilities of the end users.

As described herein, and for the sake of simplicity, this process 100 will be understood to be carried out by a processor. Those skilled in the art will recognize and appreciate that such a processor can comprise a fixed-purpose hard-wired platform or can comprise a partially or wholly programmable platform. It will also be understood that such a “processor” can comprise a single platform or can comprise a logical architecture wherein the described functionality is distributed over two or more supporting platforms. All of these architectural options are well known and understood in the art and require no further description here.

This process 100 provides for this processor receiving 101 at least one on-demand broadcasting request for particular audio-visual content from an end user. There are various ways by which this step can be carried out. By one approach, for example, the audio-visual content service provider processor can provide a programming guide to the end user that presents information to facilitate the transmission of the aforementioned on-demand broadcasting request.

This information can include, for example, a listing of available candidate on-demand broadcasting opportunities. Such a practice is known in the art. Using this approach, the end user can select a particular one of the candidate on-demand broadcasting opportunities using a selection methodology of choice (such as, for example, an on-screen selection menu and a selection tool such as a wireless hand held remote control). The selection information is then transmitted back to the audio-visual content service provider processor via the audio-visual content service provider's access network.

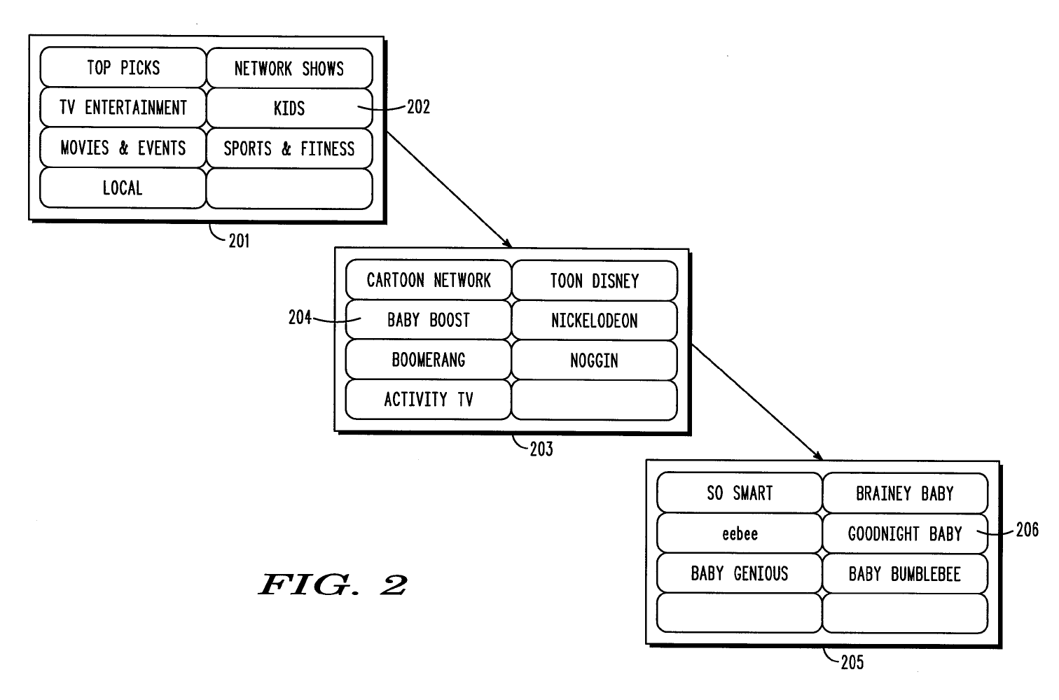

By way of illustration and not by way of limitation, and referring momentarily to FIG. 2, a display of such a programming guide can be provided to the end user via their television display screen via their so-called set-top box. (As used herein, a set-top box will be understood to comprise a device that connects to a television and an external source of signal and converts the signal into content which is then displayed on the television display screen.) As shown at reference numeral 201, this can first comprise a display of a variety of candidate viewing genres or categories, such as “movies and events,” “network shows,” and “kids” 202. In this example the end user selects “kids” 202 and the programming guide refreshes the television display screen as shown at reference numeral 203. Now, a variety of candidate options for children's viewing are shown including one option entitled “baby boost” 204. In this example the end user selects this “baby boost” 204 option and the programming guide again refreshes the display to provide the corresponding “baby boost” options as shown at reference numeral 205. In this example, the end user selects an on-demand broadcasting option entitled “goodnight baby” 206 which, in turn, causes the end user's set-top box to generate the above-described on-demand broadcasting request which identifies this particular selection.

By one approach, this received request can substantively comprise, in essence, only the request itself (along with necessary or useful content of form, such as an identifier for the end user, the end user's set-top box, and so forth). By another approach, however, this received request can further comprise additional information. One example in this regard comprises information that indicates a relative priority to be accorded the on-demand request. As used herein, the expression “relative” will be understood to refer to an indication of priority relative to other on-demand broadcasting requests as have been, are, or will be also submitted by the end user. Using this approach, for example, the end user may be offered the ability to indicate a relative priority of high, medium, or low priority. This can serve to indicate, for example, a viewing order of preference.

This process 100 then further provides for determining 102 at least one future time at which the on-demand broadcasting request can likely be satisfied. When the future time is essentially “now,” of course, the audio-visual content service provider processor can simply promptly begin the process of streaming the requested audio-visual content to the end user as per ordinary present practice in this regard. When immediate delivery is not possible, however, the audio-visual content service provider processor can then utilize this determined future time as described herein.

There are various criteria upon which such a determination can be based. By one approach, the audio-visual content service provider processor can make this determination as a function, at least in part, of anticipated broadcasting bandwidth demands. As one simple illustrative example in this regard, at the time of receiving the on-demand broadcasting request from this particular end user, all available bandwidth may be presently dedicated to streaming content (both scheduled and on-demand) to various other end users. The audio-visual content service provider processor may then further determine when, for example, another item of on-demand content will be concluded and thereby free up sufficient access network bandwidth to support the presently request on-demand broadcasting request. That particular determination, in turn, provides the basis in this illustrative example for determining the aforementioned future time.

As another illustrative example in this regard, this determination can be formed as a function, at least in part, of a level of service to be accorded to the end user. For example, when the end user requires a particular amount of bandwidth in order to receive, for example, a high definition signal with 5.2 surround sound, this determination may be based upon determining when that quantity of bandwidth may be suitably available. As another example, this determination can relate to a particular tier of service to which the end user subscribes. For example, the audio-visual content service provider may offer a first tier of service that offers prioritized access to on-demand broadcasting opportunities and a second tier of service that offers reduced priority access to such opportunities. In such a case, the requesting end user's status as a first tier subscriber or a second tier subscriber can influence, in turn, this determination regarding when the requested on-demand content can begin streaming.

There are other possible reasons why a given on-demand broadcasting request cannot be promptly honored. These include, but are not limited to, delays with respect to loading the requested content from an external server, limits (of one kind or another) that are imposed by the content publisher and/or the audio-visual content service provider, storage limitations of the audio-visual content service provider's facilities, aggregation of multiple requests for the same content within a same period of time, and so forth.

As noted above, the end user may have provided an indication to the audio-visual content service provider processor that comprises an indication of relative priority to be accorded to the received on-demand broadcasting request. In such a case, this determination regarding a future time can also be formed as a function, at least in part, of this indication of relative priority. To illustrate by way of a simple example, an earlier submitted on-demand broadcasting request from this end user may have resulted in scheduling that broadcast during a particular future time. This new request, which bears in this example a higher level of relative priority than the earlier scheduled on-demand broadcast, can be substituted in the schedule for the earlier, lower priority request.

In any event, having made this determination regarding a future time at which the on-demand broadcasting request can likely be satisfied, this process 100 then provides for providing 103 a dynamic programming guide to the end user that comprises, at least in part, the at least one future time. This dynamic programming guide can also comprise, if desired, information regarding regularly scheduled broadcasts of audio-visual content as well (that is, the non-on-demand broadcasts that are offered by the audio-visual content service provider via its access network to the end user).

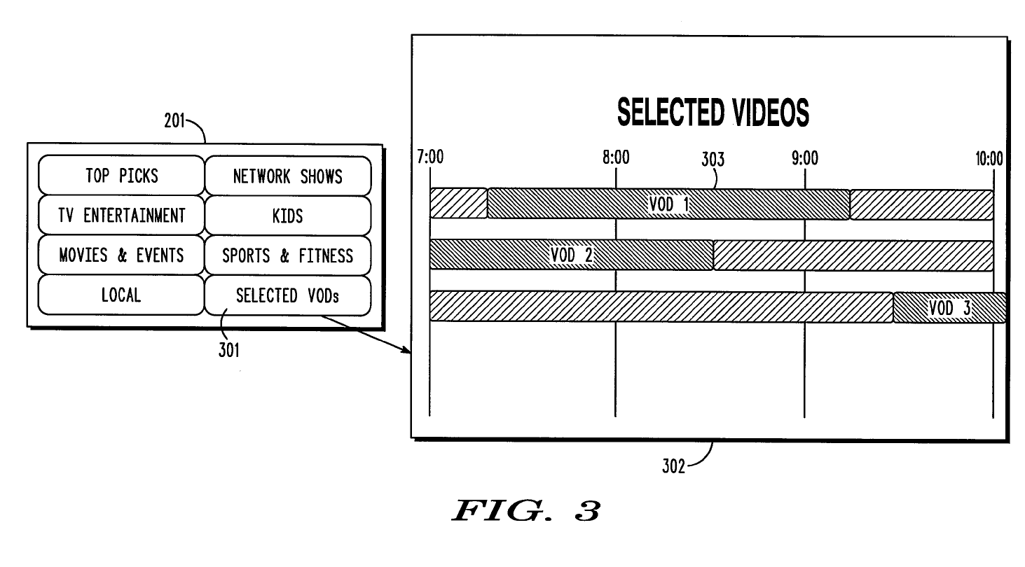

To illustrate, and again without intending any limitations in this regard, FIG. 3 presents the viewing opportunities display 201 as was described earlier but which now also includes a selectable category for “selected VODs” 301 (as the end user now has at least one selected VOD on record with the audio-visual content service provider processor). By selecting this “selected VODs” 301 option, the programming guide can refresh the display as shown at reference numeral 302 to indicate, in this example, various times on this day when various on-demand viewing options can be initiated on various channels as are available to this end user. For example, in the portion of the display which is denoted by reference numeral 303, the display indicates a period of time during which a program selection entitled “VOD 1” can be selected and playback of the selection will begin promptly.

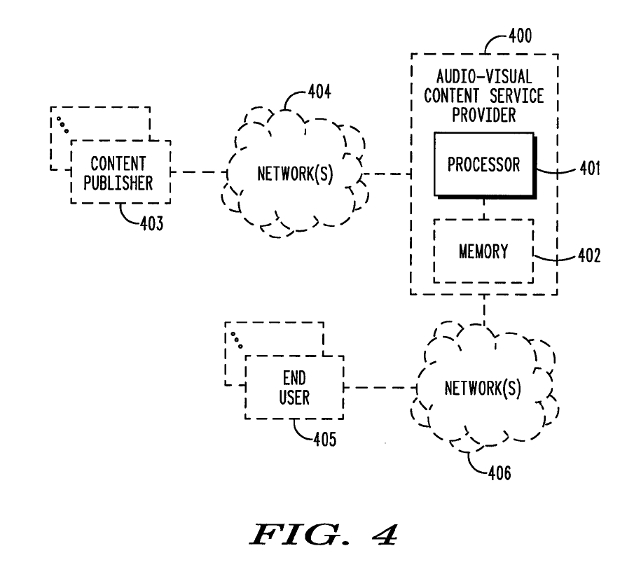

Those skilled in the art will appreciate that the above-described processes are readily enabled using any of a wide variety of available and/or readily configured platforms, including partially or wholly programmable platforms as are known in the art or dedicated purpose platforms as may be desired for some applications. Referring now to FIG. 4, an illustrative approach to such a platform will now be provided.

In this illustrative example, an audio-visual content service provider 400 comprises, in part, a processor 401 that can operably couple to a memory 402 as desired. Such a memory can serve, for example, to store audio-visual content that has been recorded by the audio-visual content service provider (to later provide, for example, to end users as on-demand broadcasting content). These facilities can operably couple to one or more content publishers 403 via one or more intervening networks 404 (such as the Internet, dedicated landlines, or other wireline/wireless carriers of choice). These content publishers 403 can source, for example, the aforementioned audio-visual content to be ultimately provided to the audio-visual content service provider's end users and the audio-visual content service provider processor 401 can receive such information via the aforementioned network(s) 404.

The audio-visual content service provider's facilities can further operably couple to one or more end users 405 (such as a plurality of residential facilities such as homes, condominiums, apartments, and so forth) via one or more intervening networks 406. This network(s) 406 may be the same, in whole or in part, as the network(s) 404 that couple the audio-visual content service provider's facilities to the content publisher(s) 403 or may be different as appropriate to the specifics of a given application setting. By one approach, this network 406 can comprise a dedicated access network such as a cable-based or a satellite-based television broadcasting distribution system as are well known in the art.

So configured, the aforementioned processor 401 can be configured and arranged, via, for example, corresponding programming as will be well understood by those skilled in the art, to carry out one or more of the aforementioned steps, actions, and functions. This can comprise, for example, receiving the aforementioned on-demand broadcasting request(s) for particular audio-visual content from various end users, determining at least one future time at which each on-demand broadcasting request can likely be satisfied, and providing a dynamic programming guide to the end user that comprises, at least in part, this at least one future time.

Those skilled in the art will recognize and understand that such a facility 400 may be comprised of a plurality of physically distinct elements as is suggested by the illustration shown in FIG. 4. It is also possible, however, to view this illustration as comprising a logical view, in which case one or more of these elements can be enabled and realized via a shared platform. It will also be understood that such a shared platform may comprise a wholly or at least partially programmable platform as are known in the art.

To further demonstrate the capabilities and effectiveness of these teachings, a more detailed description of a given illustrative instantiation will now be provided. Those skilled in the art will recognize and understand that the specifics of this example serve an illustrative purpose only and are not offered with any suggestion or intent that these specifics comprise an exhaustive listing of all such possibilities in this regard.

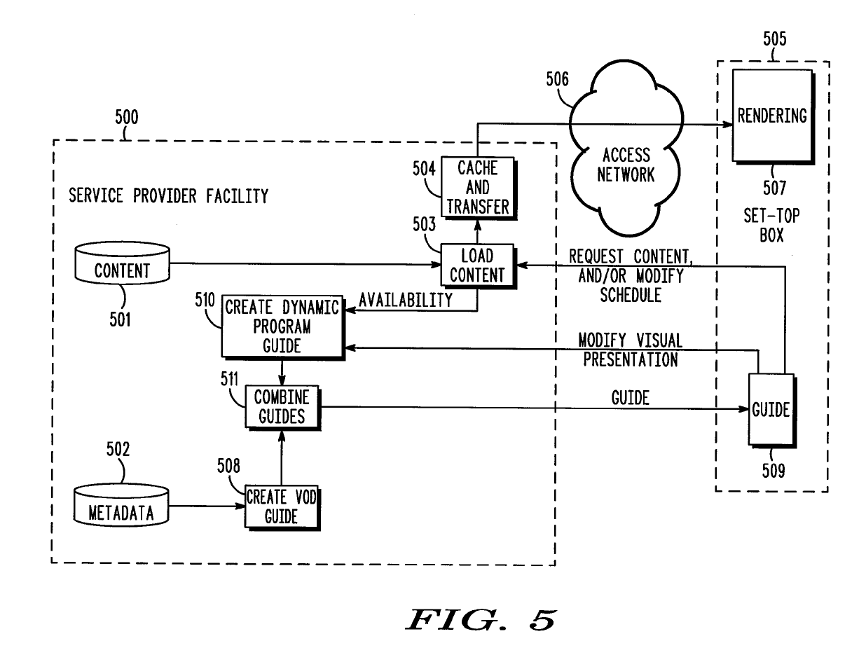

In this example, and referring now to FIG. 5, a service provider facility 500 has content storage facilities 501 and metadata storage facilities 502. The content storage facilities 501 contain audio-visual content from any desired source and the metadata storage facilities 502 contain information regarding the content and availability of such audio-visual content for on-demand broadcasting purposes. This information can also be derived from any of a variety of sources.

The audio-visual content in the content storage facilities 501 can be loaded as required by a load content capability 503 and then cached and transferred via a cache/transfer capability 504 to a given end user's set-top box 505 via the audio-visual content service provider's access network 506. A rendering capability 507 at the set-top box 505 can facilitate the rendering of this audio-visual content for consumption by the end user. Such elements and the described functionality are well known in the art and require no further elaboration here.

A guide creation capability 508 can utilize the aforementioned metadata from the metadata storage facilities 502 to form a corresponding programming guide 509. The latter is viewable by the end user via their set-top box 505 and their television display (not shown). Interaction with this programming guide 509 as described above can serve to cause the load content capability 503 to effect the prompt provision of requested on-demand content when such is available for immediate streaming.

Upon receiving such a content request, the load content capability 503 probes a dynamic program guide creation capability 510 to determine, as described above, whether the requested content is, in fact, available for current delivery to the end user. When such is not the case, the dynamic program guide 510 can determine the future time or times when an on-demand request can likely be immediately honored as described above and this information can be provided to a combination capability 511 that combines the content from the VOD guide creator capability 508 and the dynamic program guide creation capability 510 to provide this combined content in a single program guide 509 to the end user. The end user can then use this information to identify when a current on-demand request will be honored.

If desired, and as shown, the end user can also interact with how the VOD content is to be delivered. One example is to signal the load content facility 503 (via the programming guide 509) to delete a previous on-demand broadcasting request. This, in turn, can cause the requested content to be deleted via the dynamic program guide creator capability 510 which will cause, in turn, a corresponding update to the program guide 509 itself.

As another example in this regard, the end user may also request to prioritize (using, for example, prioritization levels such as high, medium or low) and/or to order (by indicating, for example which selection is preferred first, which second, which third, and so on) specific VOD requests via the load content facility 503. Such requests are taken into consideration by the load content facility 503 and can result in corresponding modifications to the presentation time of the requested VODs.

The end user may also wish to interact with the visual representation of the guide by using the guide 509 to interact with the creation of the dynamic program guide 510. For example, the visual representation of the guide 509 may be changed with respect to its time scale by zooming in and/or out of the portrayed VOD schedule. Additional interaction with the display of the guide 509 may include showing available VODs for specific days, highlighting VODs with specific keywords, and so forth. It should be noted that changing the visual presentation of the guide 509 does not necessarily change what VODs will be made available or at what time they will be available.

Those skilled in the art will recognize and appreciate that these teachings provide a simple yet powerful mechanism by which an audio-visual content service provider processor can automatically ascertain when an on-demand broadcasting request that cannot be presently met can be honored. These teachings also provide an effective and intuitive mechanism by which an end user can receive and use such information via their accustomed interface with the services of the audio-visual content service provider.

Those skilled in the art will recognize that a wide variety of modifications, alterations, and combinations can be made with respect to the above described embodiments without departing from the spirit and scope of the invention, and that such modifications, alterations, and combinations are to be viewed as being within the ambit of the inventive concept.

We claim:

1. A method comprising:
at an audio-visual content service provider processor:
receiving at least one on-demand broadcasting request for particular audio-visual content from an end user;
determining at least one future time at which the on-demand broadcasting request can likely be satisfied;
providing a dynamic programming guide to the end user that comprises, at least in part, the at least one future time.

2. The method of claim 1 wherein receiving at least one on-demand broadcasting request from an end user comprises, at least in part:
providing an earlier version of the dynamic programming guide that presents candidate on-demand broadcasting opportunities including the particular audio-visual content to thereby provide the end user with information to facilitate the end user transmitting the at least one on-demand broadcasting request.

3. The method of claim 1 wherein determining at least one future time at which the on-demand broadcasting request can likely be satisfied comprises, at least in part, determining the at least one future time as a function, at least in part, of anticipated broadcasting bandwidth demands.

4. The method of claim 1 wherein determining at least one future time at which the on-demand broadcasting request can likely be satisfied comprises, at least in part, determining the at least one future time as a function, at least in part, of a level of service to be accorded to the end user.

5. The method of claim 1 wherein providing a dynamic programming guide comprises providing a programming guide that also presents information regarding regularly scheduled broadcasts of audio-visual content.

6. The method of claim 1 wherein:
receiving at least one on-demand broadcasting request for particular audio-visual content from an end user comprises receiving an on-demand broadcasting request that includes an indication of relative priority;
determining at least one future time at which the on-demand broadcasting request can likely be satisfied comprises determining the at least one future time as a function, at least in part, of the indication of relative priority.

7. The method of claim 1 wherein determining at least one future time at which the on-demand broadcasting request can likely be satisfied comprises, at least in part, determining the at least one future time as a function, at least in part, of a preferences profile as corresponds to the end user.

8. An apparatus comprising:
an audio-visual content service provider processor that is configured and arranged to:
receive at least one on-demand broadcasting request for particular audio-visual content from an end user;
determine at least one future time at which the on-demand broadcasting request can likely be satisfied;
provide a dynamic programming guide to the end user that comprises, at least in part, the at least one future time.

9. The apparatus of claim 8 wherein the audio-visual content service provider processor is further configured and arranged to receive at least one on-demand broadcasting request from an end user by, at least in part, providing an earlier version of the dynamic programming guide that presents candidate on-demand broadcasting opportunities including the particular audio-visual content to thereby provide the end user with information to facilitate the end user transmitting the at least one on-demand broadcasting request.

10. The apparatus of claim 8 wherein the audio-visual content service provider processor is further configured and arranged to determine at least one future time at which the on-demand broadcasting request can likely be satisfied by, at least in part, determining the at least one future time as a function, at least in part, of anticipated broadcasting bandwidth demands.

11. The apparatus of claim 8 wherein the audio-visual content service provider processor is further configured and arranged to determine at least one future time at which the on-demand broadcasting request can likely be satisfied by, at least in part, determining the at least one future time as a function, at least in part, of a level of service to be accorded to the end user.

12. The apparatus of claim 8 wherein the audio-visual content service provider processor is further configured and arranged to provide a dynamic programming guide by providing a programming guide that also presents information regarding regularly scheduled broadcasts of audio-visual content.

13. The apparatus of claim 8 wherein the audio-visual content service provider processor is further configured and arranged to:
receive at least one on-demand broadcasting request for particular audio-visual content from an end user by receiving an on-demand broadcasting request that includes an indication of relative priority;
determine at least one future time at which the on-demand broadcasting request can likely be satisfied by determining the at least one future time as a function, at least in part, of the indication of relative priority.

14. The apparatus of claim 8 wherein the audio-visual content service provider processor is further configured and arranged to determine at least one future time at which the on-demand broadcasting request can likely be satisfied by, at least in part, determining the at least one future time as a function, at least in part, of a preferences profile as corresponds to the end user.
